(19) United States
(12) Patent Application Publication
(10) Pub. No.: US 2025/0165777 A1
(43) Pub. Date: May 22, 2025

(54) TECHNIQUES FOR TRAINING VISION FOUNDATION MODELS VIA MULTI-TEACHER DISTILLATION

(71) Applicant: NVIDIA CORPORATION, Santa Clara, CA (US)

(72) Inventors: Michael RANZINGER, Park City, UT (US); Gregory HEINRICH, Nice (FR); Jan KAUTZ, Lexington, MA (US); Pavlo MOLCHANOV, Mountain View, CA (US)

(21) Appl. No.: 18/740,294

(22) Filed: Jun. 11, 2024

Related U.S. Application Data
(60) Provisional application No. 63/601,704, filed on Nov. 21, 2023.
(60) Provisional application No. 63/604,136, filed on Nov. 29, 2023.

(51) Int. Cl. G06N 3/08; G06N 3/045

(52) U.S. Cl. CPC G06N 3/08; G06N 3/045

(57) ABSTRACT

One embodiment of a method for training a first machine learning model includes processing first data via a plurality of trained machine learning models to generate a plurality of first outputs, processing the first data via the first machine learning model to generate a second output, processing the second output via a plurality of projection heads to generate a plurality of third outputs, computing a plurality of losses based on the plurality of first outputs and the plurality of third outputs, and performing one or more operations to update one or more parameters of the first machine learning model and one or more parameters of the plurality of projection heads based on the plurality of losses.

### CROSS-REFERENCE TO RELATED APPLICATIONS

This application claims priority benefit of the United States Provisional patent application titled, “TECHNIQUES FOR TRAINING VISION FOUNDATION MODELS VIA MULTI-TEACHER DISTILLATION,” filed on Nov. 21, 2023 and having Ser. No. 63/601,704 and United States Provisional application titled, “TECHNIQUES FOR TRAINING VISION FOUNDATION MODELS VIA MULTI-TEACHER DISTILLATION,” filed on Nov. 29, 2023 and having Ser. No. 63/604,136. The subject matter of these related applications are hereby incorporated herein by reference.

### BACKGROUND

### Technical Field

Embodiments of the present disclosure relate generally to computer science, artificial intelligence (AI), and machine learning and, more specifically, to techniques for training vision foundation models via multi-teacher distillation.

### Description of the Related Art

Machine learning can be used to discover trends, patterns, relationships, and/or other attributes related to large sets of complex, interconnected, and/or multidimensional data. To glean insights from large data sets, regression models, artificial neural networks, support vector machines, decision trees, naive Bayes classifiers, and/or other types of machine learning models can be trained using input-output pairs in the data. In turn, the trained machine learning models can be used to guide decisions and/or perform actions related to the data and/or other similar data.

Foundation models (FMs) are machine learning models that are oftentimes trained on large amounts of data so that the FMs can perform a broad range of tasks. Visual Foundation Models (VFMs) are a subset of FMs that are trained to perform tasks relating to visual data, such as images and videos. For example, the tasks that a VFM can be trained to perform include image classification, semantic segmentation and object detection. Image classification is a task that assigns a label to an image from a predefined set of categories to specify the main subject of the image. Semantic segmentation is a task that assigns a label to each pixel in an image from a predefined set of categories in order to split apart objects within the image. Object detection is a task that identifies objects within an image by, for example, drawing a bounding box around each object.

One drawback of conventional FMs, and conventional VFMs in particular, is that these FMs oftentimes perform significantly worse on some tasks than other tasks. For example, a given VFM could perform well for an image classification task but not perform as well as on a semantic segmentation task. At the same time, another VFM could perform well on the semantic segmentation task but not perform as well on the image classification task.

As the foregoing illustrates, what is needed in the art are more effective FMs.

### SUMMARY

One embodiment of the present disclosure sets forth a computer-implemented method for training a first machine learning model. The method includes processing first data via a plurality of trained machine learning models to generate a plurality of first outputs. The method also includes processing the first data via the first machine learning model to generate a second output. The method further includes processing the second output via a plurality of projection heads to generate a plurality of third outputs. The method also includes computing a plurality of losses based on the plurality of first outputs and the plurality of third outputs. In addition, the method includes performing one or more operations to update one or more parameters of the first machine learning model and one or more parameters of the plurality of projection heads based on the plurality of losses.

Other embodiments of the present disclosure include, without limitation, one or more computer-readable media including instructions for performing one or more aspects of the disclosed techniques as well as one or more computing systems for performing one or more aspects of the disclosed techniques.

At least one technical advantage of the disclosed techniques relative to the prior art is that the disclosed techniques can be used to generate relatively accurate and stable student foundation models that perform well across different tasks. The disclosed techniques also allow the student models to have an architecture that is distinct from the architecture of any teacher model. In addition, the trained student models can be faster and more data efficient, since the disclosed techniques do not rely on any prior feature shapes or model architecture. These technical advantages represent one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a block diagram of a computer-based system configured to implement one or more aspects of the various embodiments;

FIG. 2 is a more detailed illustration of the multi-teacher model trainer in FIG. 1, according to various embodiments;

FIGS. 3A-3B are more detailed illustrations of the student model in FIG. 1, according to various embodiments;

FIG. 4 is a more detailed illustration of the application of FIG. 1, according to various embodiments;

FIG. 5 is a flow diagram of method steps for training a student model, according to various embodiments; and

FIG. 6 is a flow diagram of method steps for using a trained student model to perform one or more tasks, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### System Overview

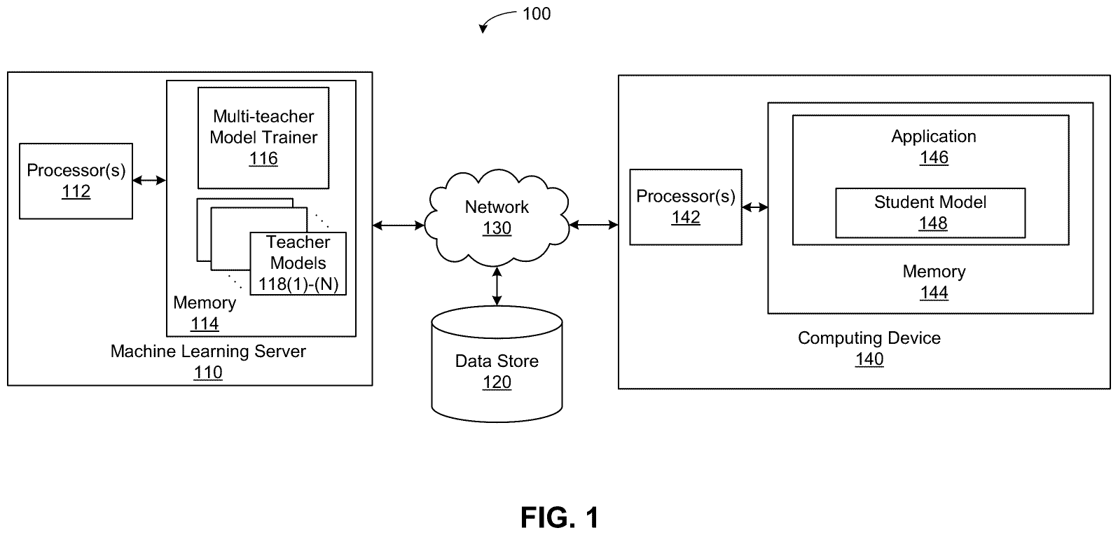

FIG. 1 illustrates a block diagram of a computer-based system 100 configured to implement one or more aspects of the various embodiments. As shown, system 100 includes a machine learning server 110, a data store 120, and a computing device 140 in communication over a network 130, which can be a wide area network (WAN) such as the Internet, a local area network (LAN), a cellular network, and/or any other suitable network.

Machine learning server 110 includes, without limitation, processor(s) 112 and a system memory 114. Processor(s) 112 receive user input from input devices, such as a keyboard or a mouse. In operation, processor(s) 112 may include one or more primary processors that control and coordinate the operations of the other system components within machine learning server 110. In particular, processor(s) 112 can issue commands that control the operation of one or more graphics processing units (GPUs) (not shown) and/or other parallel processing circuitry (e.g., parallel processing units, deep learning accelerators, etc.) that incorporates circuitry optimized for graphics and video processing, including, for example, video output circuitry. The GPU(s) can deliver pixels to a display device that can be any conventional cathode ray tube, liquid crystal display, light-emitting diode display, and/or the like.

System memory 114 of machine learning server 110 stores content, such as software applications and data, for use by processor(s) 112 and the GPU(s) and/or other processing units. System memory 114 can be any type of memory capable of storing data and software applications, such as a random-access memory (RAM), a read-only memory (ROM), an erasable programmable read-only memory (EPROM or Flash ROM), or any suitable combination of the foregoing. In some embodiments, a storage (not shown) can supplement or replace system memory 114. The storage can include any number and type of external memories that are accessible to processor 112 and/or the GPU. For example, and without limitation, the storage can include a Secure Digital Card, an external Flash memory, a portable compact disc read-only memory (CD-ROM), an optical storage device, a magnetic storage device, and/or any suitable combination of the foregoing.

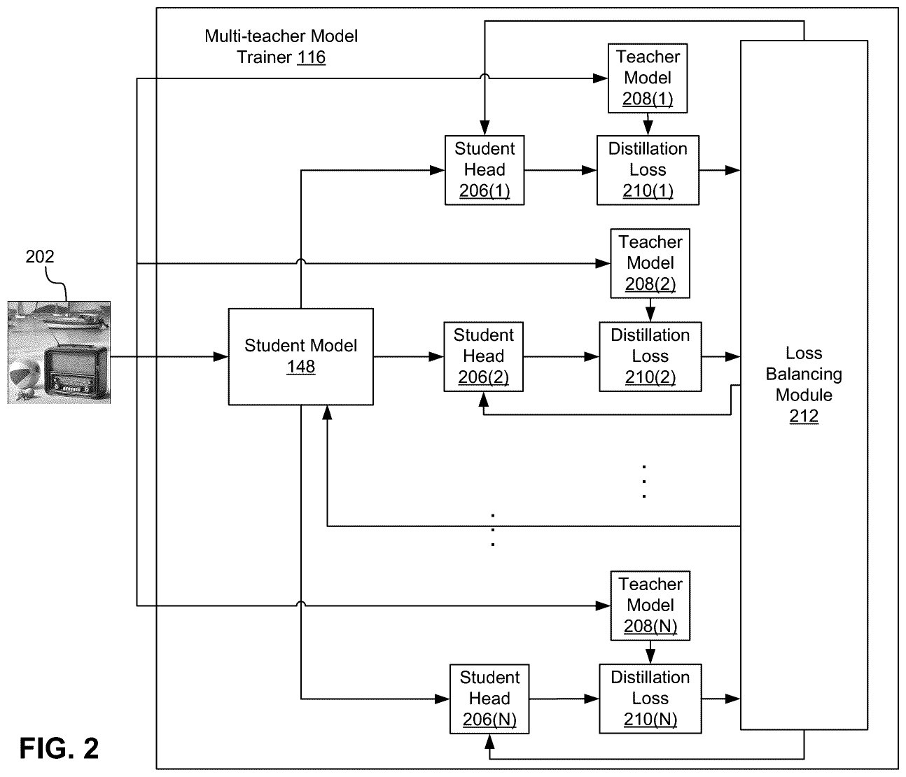

As also shown, memory 114 includes a multi-teacher model trainer 116 and teacher models 118(1)-(N). Multi-teacher model trainer 116 is configured to train a student machine learning model 148 (also referred to herein as “student model 148”), which can then be deployed in any suitable application, shown as an application 146 that executes on a computing device 140. In some embodiments, multi-teacher model trainer 116 uses teacher models 118(1)-(N) to train student model 148. Teacher models 118(1)-(N) can be any trained machine learning models, such as foundational models (FMs) or visual foundational models (VFMs). In some embodiments, teacher models 118(1)-(N) can be trained in any technically feasible manner to perform a broad range of tasks. In some embodiments, teacher models 118(1)-(N) can be trained in a local server or in the cloud. In some embodiments, teacher models 118(1)-(N) can be stored in the data store 120, a network storage, or a cloud storage. During training of student model 148 using teacher models 118(1)-(N), teacher models 118(1)-(N) are used to distill knowledge into the single student model 148. Any number of teacher models 118(1)-(N) can be used by multi-teacher model trainer 116 to train student model 148 in some embodiments. Operations that multi-teacher model trainer 116 can perform to train student model 148 are described in greater detail below in conjunction with FIGS. 2-6.

The machine learning server 110 shown herein is for illustrative purposes only, and variations and modifications are possible without departing from the scope of the present disclosure. For example, the number of processors 112, the number of GPUs and/or other processing unit types, the number of system memories 114, and/or the number of applications included in the system memory 114 can be modified as desired. Further, the connection topology between the various units in FIG. 1 can be modified as desired. In some embodiments, any combination of the processor(s) 112, the system memory 114, and/or GPU(s) can be included in and/or replaced with any type of virtual computing system, distributed computing system, and/or cloud computing environment, such as a public, private, or a hybrid cloud system.

The computing device 140 includes, without limitation, processor(s) 142 and a memory 144. Processor(s) 142 receive user input from input devices, such as a keyboard or a mouse. Similar to processor(s) 112 of machine learning server 110, in some embodiments, processor(s) 142 may include one or more primary processors that control and coordinate the operations of the other system components within the computing device 140. In particular, the processor(s) 142 can issue commands that control the operation of one or more graphics processing units (GPUs) (not shown) and/or other parallel processing circuitry (e.g., parallel processing units, deep learning accelerators, etc.) that incorporates circuitry optimized for graphics and video processing, including, for example, video output circuitry. The GPU(s) can deliver pixels to a display device that can be any conventional cathode ray tube, liquid crystal display, light-emitting diode display, and/or the like.

Similar to system memory 114 of machine learning server 110, system memory 144 of computing device 140 stores content, such as software applications and data, for use by the processor(s) 142 and the GPU(s) and/or other processing units. The system memory 144 can be any type of memory capable of storing data and software applications, such as a random-access memory (RAM), a read-only memory (ROM), an erasable programmable read-only memory (EPROM or Flash ROM), or any suitable combination of the foregoing. In some embodiments, a storage (not shown) can supplement or replace the system memory 144. The storage can include any number and type of external memories that are accessible to processor 142 and/or the GPU. For example, and without limitation, the storage can include a Secure Digital Card, an external Flash memory, a portable compact disc read-only memory (CD-ROM), an optical storage device, a magnetic storage device, and/or any suitable combination of the foregoing.

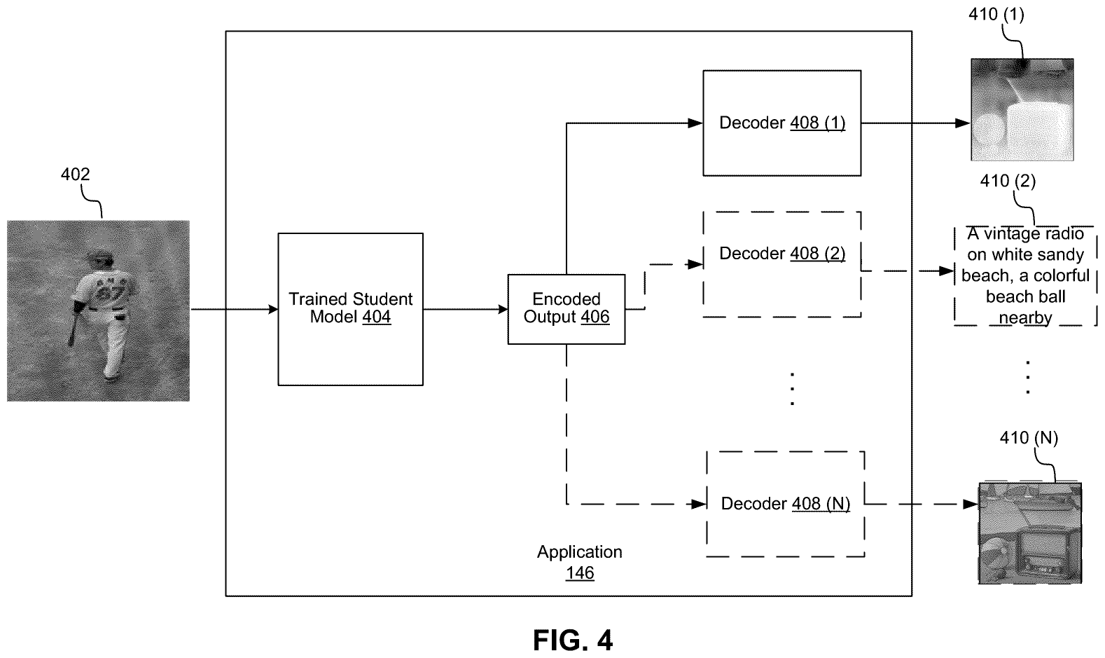

As also shown, system memory 142 includes application 146 that generates one or more task specific outputs. Examples of tasks that could be performed by an application such as application 146 include image classification, object detection, and/or semantic segmentation. More specifically, application 146 uses student model 148 that is trained by multi-teacher model trainer 116 to generate encoded outputs. Application 146 then uses the encoded outputs to generate one or more task specific outputs. As described, student model 148 can be any type of technically feasible machine learning model. For example, in various embodiments, student model 148 can be a VFM, with any suitable architecture such as a Convolutional Neural Network (CNN) or a diffusion model. The operations performed by application 146 when generating task specific outputs are described in greater detail below in conjunction with FIG. 4.

Data store 120 provides non-volatile storage for applications and data in machine learning server 110 and computing device 140. For example, and without limitation, training data, trained (or deployed) machine learning models and/or application data, including the student model 148, may be stored in the data store 120. In some embodiments, data store 120 may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. Data store 120 can be a network attached storage (NAS) and/or a storage area-network (SAN). Although shown as accessible over network 130, in various embodiments, the machine learning server 110 or computing device 140 can include the data store 120.

### Training Machine Learning Model Via Multi-Teacher Distillation

FIG. 2 is a more detailed illustration of the multi-teacher model trainer 116 in FIG. 1, according to various embodiments. As shown, multi-teacher model trainer 116 includes a student model 148, student heads 206(1)-(N) (referred to herein collectively as student heads 206 and individually as a student head 206), teacher models 208(1)-(N) (referred to herein collectively as teacher models 208 and individually as a teacher model 208), distillation losses 210(1)-(N) (referred to herein collectively as distillation losses 210 and individually as a distillation loss 210), and a loss balancing module 212. In operation, multi-teacher model trainer 116 receives training images (shown as training image 202) and one or more teacher model(s) 208(1)-(N) from memory 114, storage 120, or any other storage. Multi-teacher model trainer 116 then trains student model 148 using the received images and ground truth features generated by teacher models 208.

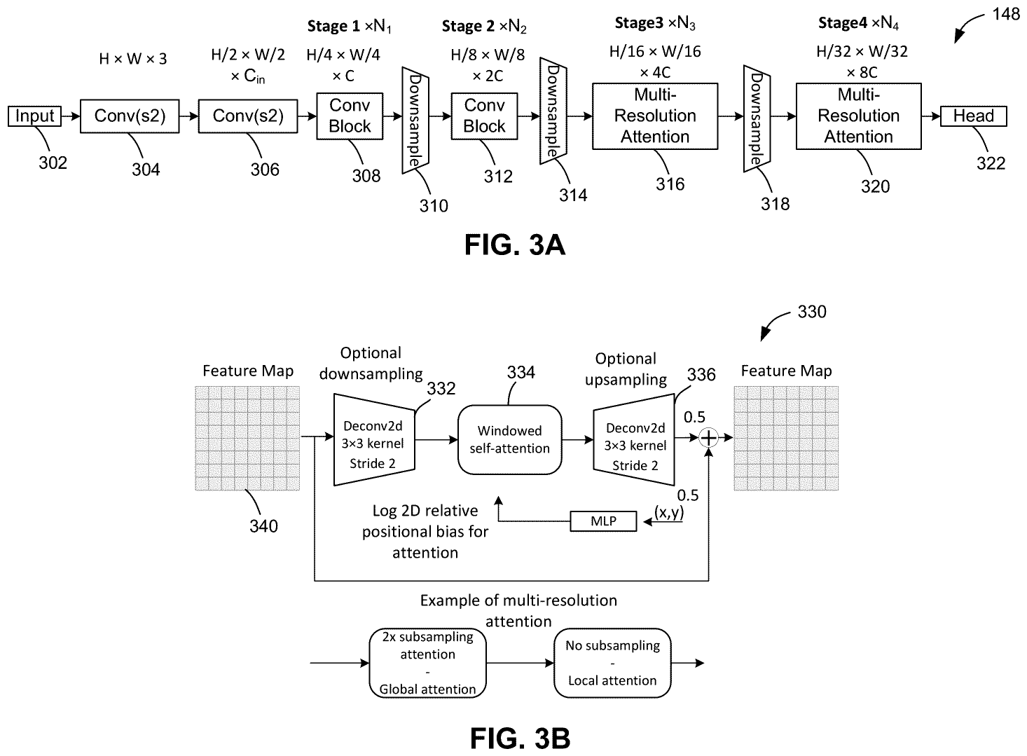

As described, student model 148 can be any technically feasible machine learning model trainable to generate encoded output that can then be decoded by a decoder model to perform one or more tasks. In some embodiments, student model 148 can be a VFM with any suitable architecture. In such cases, student model 148 receives an image (e.g., image 202) and generates an encoded output. An example student model 148 is described in greater detail below in conjunction with FIG. 3.

Teacher models 208 can be any suitable machine learning models including, but not limited to, neural networks, decision trees, support vector machines, and ensemble techniques. In some embodiments, each teacher model 208 can be an FM or a VFM with any technically feasible model architecture. In some embodiments, each teacher model 208 processes a received image 202 and generates image-level features as well as spatial feature vectors. In a case where the teacher model 208 is a VFM, the features can be output by an encoder of the VFM.

When teacher models 208 are VFM models, image-level features can be computed for an entire image. Image-level features are summary features for an entire image which can be computed differently based on the architecture of the teacher model 208. For example, when a Contrastive Language-Image Pre-training (CLIP) model is used as a teacher model 208, a class token could be selected for the image-level feature. As a specific example, when a teacher model 208 is classifying cats and dogs, the class token could be “cat” for all cat images and “dog” for all dog images. When a Segment Anything Model (SAM) is used as a teacher model 208, the average of the spatial feature vectors can be used for the image-level feature. Spatial features are feature vectors for each patch of an image. Returning to the example of classifying cats and dogs, spatial features can be different for cat images depending on where the cat appears in the image. In some embodiments, when a teacher model 208 is a Vision Transformer (ViT), spatial feature vectors can come from the final layer of the model for each image patch.

To distill knowledge from teacher models 208 with different model architectures into student model 148, summary and spatial features between each teacher model 208 and student model 148 need to be matched. To perform such a matching, student heads 206 are projection heads that receive encoded outputs of student model 148 and generate matching features to the features generated by teacher models 208 by mapping student model 148 encoded outputs independently to each teacher model 208 using teacher-specific projection heads 206. In some embodiments, student heads 206 for summary features are separate from student heads 206 for spatial features. In some embodiments, each of student heads 206 can be a multi-layer perceptron (MLP) or have any other technically feasible architecture with parameters that can be updated by multi-teacher model trainer 116 using a combination of losses during training. In some embodiments, the architecture of each of student heads 206 can be relatively simple (e.g., a 2-layer MLP) in order to fully transfer the knowledge from teacher models 208 to student model 148.

In cases where the input image resolution is different for each teacher model 208, the spatial features generated by each teacher model 208 having a different input image resolution can be interpolated to match the spatial features size of student model 148. For example, if a teacher model 208 has spatial features with output patches that are smaller than student model 148 output patches, the spatial features could be upscaled to match the output patches of student model 148. Any technically feasible interpolation can be used to upscale spatial features, such as bilinear or bicubic interpolation.

In some embodiments, even if the input image resolution for each teacher model 208 is the same or similar to student model 148, the spatial features generated by each teacher model 208 and student model 148 may be different, such as when student model 148 uses a patch size to process an input image that is different from the patch size that teacher model 208 uses to process the input image. In some embodiments, input images can be interpolated before being processed by teacher model 208 to match the student model 148 input image resolution. That is, rather than interpolating spatial features to match dimensions of the spatial features generated by each teacher model 208 and student model 148, as described above, input image pixels can be interpolated instead.

Distillation losses 210 compute image-level losses and spatial losses for each corresponding teacher model 208. Image-level losses are computed based on image-level feature differences between each corresponding teacher model 208 and student model 148. Differences of image-level features can be computed using any technically feasible metric, such as Cosine similarity, L1, Mean Square Error (MSE), and/or smooth-L1. An example of the loss function for image-level features that can be computed using a Cosine metric is shown in equation (1):

$${L}_{cos} ( {y}_{i}^{( s )} , {z}_{i}^{( s )} ) = 1 - \frac{{y}_{i}^{{( s )}^{T}} {z}_{i}^{( s )}}{\vert {y}_{i}^{( s )} \vert \vert {z}_{i}^{( s )} \vert} , \qquad ( 1 )$$

where x is input image, x′=f(x|Θ₀) is the student model 148 vision encoder with parameters Θ₀, and yᵢ^{s}=hᵢ^{(s)}(x′|Θᵢ^{(s)}) is the learned student head 206 matching teacher summary features zᵢ^{(s)}=tᵢ^{(s)}(x|Φᵢ) with student adaptor parameters Θᵢ^{(s)} and teacher parameters Φᵢ.

Distillation losses 210 compute spatial losses based on spatial features differences between outputs generated by each corresponding teacher model and student model 148. The differences between spatial features can be computed using any technically feasible metric, such as Cosine similarity, L1, Mean Square Error (MSE), and/or smooth-L1. An example of the loss function for spatial features using the Cosine similarity metric can be computed using equation (2). In this example, to incorporate the magnitude of the teacher model spatial features, a smooth L1 can be added to the loss function.

$${L}_{match} ( y , z ) = α {L}_{cos} ( y , z ) + β {L}_{smooth 1} ( y , z ) , \qquad ( 2 )$$

where, y=hᵢ^{(v)}(x′|Θᵢ^{(v)}) is the learned student head for matching corresponding teacher spatial features, and z=tᵢ^{(v)}(x|Φᵢ^{(v)}) is the corresponding teacher spatial features, with x′=f(x|Θ₀), and x is the input image. In some embodiments, distillation losses 210 can adjust α and β to modify the weight of each term of the spatial loss. For example, when choosing α=0.9 and β=0.1, the spatial loss mostly relies on cosine distance and less on the smooth L1 distance.

Loss balancing module 212 aggregates losses and sets loss function weighting parameters. The loss function weighting parameters control the number of possible combinations of loss function terms between different teachers, choosing the teacher models included during the training and/or formulation of loss functions. Loss balancing module 212 receives image-level losses and spatial losses from distillation losses 210 corresponding to teacher models 208 and generates an aggregated loss. An example of an aggregated loss for summary features with Cosine metric is defined in equation (3):

$${L}_{summary features} ( x ) = {\sum }_{i} {λ}_{i} {L}_{cos} ( {y}_{i}^{( s )} , {z}_{i}^{( s )} ) , \qquad ( 3 )$$

where, λᵢ controls the weight of each teacher model 208 on the overall image-level loss. For example, when the CLIP, DINO, and SAM teacher models are used for knowledge distillation into student model 148, setting λ_{CLIP}×λ_{DINO}=1 and λ_{SAM}=0.1 decreases the impact of the SAM model compared to the CLIP and DINO models because SAM model has low performance in the classification task.

An example of aggregated loss for spatial features with Cosine metric is defined in equation (4):

$${L}_{spatial features} ( x ) = {\sum }_{i} {γ}_{i} {L}_{match} ( {h}_{i}^{( v )} ( {x}^{′} \vert {Θ}_{i}^{( v )} ) , {t}_{i}^{( v )} ( x \vert {Φ}_{i}^{( v )} ) ) ) , \qquad ( 4 )$$

where, γᵢ controls the weight of each teacher model on the overall spatial loss. For example, by selecting γᵢ=1, teacher models 208 are equally weighted when aggregating spatial losses corresponding to each teacher model 208.

During training, the aggregated image-level losses and spatial losses are used to compute gradients for backpropagation to update parameters of student model 148 and student heads 206. By default, loss balancing module 212 can set weighting parameters to 1 to consider different loss terms equally. In some embodiments, loss balancing module 212 can set fixed values for each weighting parameter before the training begins. In some other embodiments, loss balancing module 212 can automatically change the weighting parameters using any known scheduling algorithm, such as AdaLoss and Adaptive Multi-Teacher Multi-level Knowledge Distillation (AMTML-KD).

FIGS. 3A-3B are more detailed illustrations of student model 148 in FIG. 1, according to various embodiments. FIG. 3A shows an exemplar high-level architecture of student model 148 that is referred to herein as E-RADIO. The E-RADIO architecture is a hybrid Convolution Neural Network (CNN)-Transformer architecture. As shown, a stem of the E-RADIO architecture includes two convolutional layers 304 and 306 to process at input image 302. The first convolutional layer 304 generates output with similar input image dimensions and three image filters. The second convolutional layer 306 reduces input image dimensions to half and increases the number of image filters to Cin.

The rest of the E-RADIO architecture includes four stages. Every stage, except the last stage, is followed by a downsample block 310, 314, or 318. Each downsample block 310, 314, or 318 can be implemented as a strided convolution with 3×3 kernel and stride 2 which reduces image dimensions in half, followed by batch normalization layer. The first two stages follow a convolution paradigm with a C2f building block similar to building blocks used in the You Only Look Once version 8 (YOLOv8) architecture. Every convolution building block 308 and 312 doubles the number of generated image filters.

The last two stages have a transformer architecture with windowed attention and multi-resolution attention (MRA) structure. The structure of MRA 330 is shown in FIG. 3B, where every layer in the transformer has a local windowed attention 334 with optional subsampling via a convolutional operator 332. For example, if subsampling is disabled, then MRA is just a standard windowed attention. If the subsampling ratio is 2, then a feature map 340 received at that stage is downsampled by a factor of 2, windowed attention is performed, and then the feature map is upsampled 336 to the original resolution with deconvolution. In some other embodiments, the MRA structure 330 can include an interleaved subsampling attention with ratio 2 and then a normal attention with no subsampling.

FIG. 4 is a more detailed illustration of application 146, according to various embodiments. As shown, application 146 includes a trained student model 404 and decoders 408(1)-(N) (referred to herein collectively as decoders 408 and individually as a decoder 408). In operation, application 146 receives input image 402 associated with a task from memory 114, storage 120, or any other storage. Although described herein within respect to images and VFMs as a reference example, in some embodiments, student machine learning models can have any technically feasible architecture and take any suitable inputs (e.g., text inputs). In some embodiments, application 146 can receive multiple images 402 associated with different tasks. Application 146 first generates encoded output 406 by applying trained student model to image 402 and then generates one or more decoder outputs 410(1)-(N) (referred to herein collectively as decoder outputs 410 and individually as a decoder output 410) using decoders 408.

Trained student model 404 is the output of multi-teacher model trainer 116 after training is completed with training images 202. Trained student model 404 receives input image 402 and generates encoded output 406 that can be decoded by a decoder 408. In some embodiments, trained student model 404 receives multiple images 402 associated with different tasks. In such cases, trained student model 404 can generate multiple encoded outputs 406. Trained student model 404 can generate an encoded output 406 for each task among different tasks.

Each of decoders 408 can be any technically feasible machine learning model that can be trained to generate decoder outputs 410. In some embodiments, one or more decoders 408 can be used in application 146. In some other embodiments, decoders 408 can generate one or more outputs associated with one or more tasks, such as image classification, semantic segmentation, and/or caption generation. An example of a decoder output 410 can be a caption for an image, a segmented image, and/or a heatmap image. In some embodiments, decoders 408 can include the decoders of a VFM with any suitable architecture.

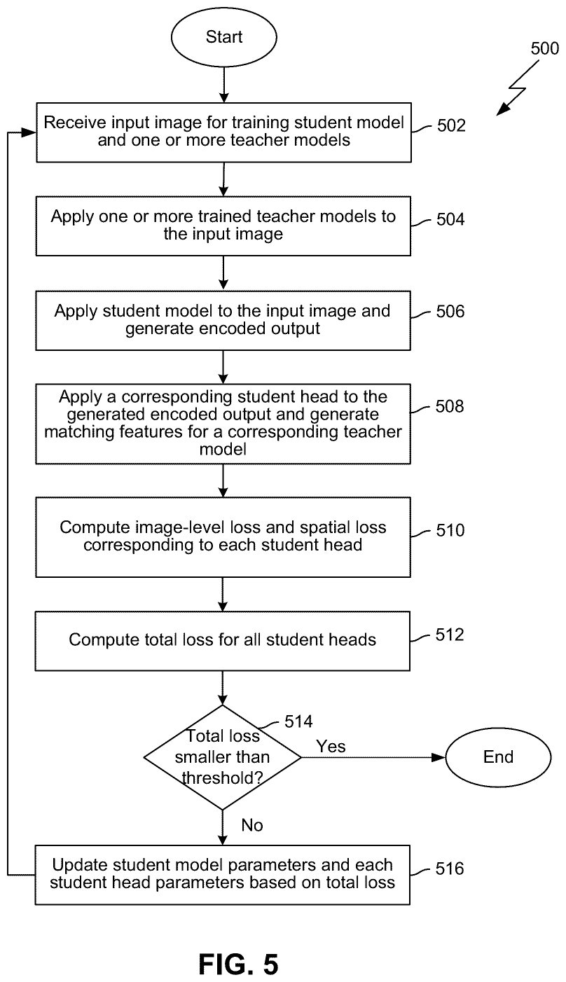

FIG. 5 is a flow diagram of method steps for training student model 148, according to various embodiments. Although the method steps are described in conjunction with the systems of FIGS. 1-4, persons skilled in the art will understand that any system configured to perform the method steps in any order falls within the scope of the present embodiments.

As shown, a method 500 begins at step 502, where multi-teacher model trainer 116 receives for training an input image and one or more teacher model(s) 208 from memory 114, storage 120, and/or any other storage. Teacher models 208 can be any suitable machine learning models including, but not limited to, neural networks, decision trees, support vector machines, and ensemble techniques. In some embodiments, each teacher model 208 can be an FM or a VFM with any technically feasible model architecture.

At step 504, multi-teacher model trainer 116 applies the one or more trained teacher models 208 to the input image. In some embodiments, each teacher model 208 processes an input image and generates image-level features as well as spatial feature vectors. In a case where the teacher model 208 is a VFM, the features can be output by an encoder of the VFM. Image-level features are summary features for an entire image which can be computed differently based on the architecture of the teacher model 208. For example, when a Contrastive Language-Image Pre-training (CLIP) model is used as a teacher model 208, a class token could be selected for the image-level feature.

At step 506, multi-teacher model trainer 116 applies student model 148 to the input image 202 and generates encoded output 406. Student model 148 can be any technically feasible machine learning model that can be trained to generate embeddings that can then be decoded by a decoder model to perform one or more tasks. In some embodiments, student model 148 can be a VFM with any suitable architecture. In such cases, student model 148 receives an image (e.g., image 202) and generates an encoded output. An example student model 148 is described above in conjunction with FIG. 3.

At step 508, multi-teacher model trainer 116 applies a corresponding student head 206 to the generated encoded output 406 and generates matching features for a corresponding teacher model 208. To distill knowledge from teacher models 208 with different model architectures into student model 148, summary and spatial features between each teacher model and student model 148 need to be matched. To perform such a matching, student heads 206 receive encoded outputs of student model 148 and generate matching features to the features generated by teacher models 208 by mapping student model 148 encoded outputs independently to each teacher model 208 using teacher-specific projection heads 206. In some embodiments, student heads 206 for summary features are separate from student heads 206 for spatial features. Each of student heads 206 can be a multi-layer perceptron (MLP) or have any other technically feasible architecture with parameters that can be updated by multi-teacher model trainer 116 using a combination of losses during training.

In some embodiments, the architecture of student heads 206 can be relatively simple in order to fully transfer the knowledge from teacher models 208 to student model 148. In cases where the input image resolution is different for each teacher model 208, the spatial features generated by each teacher model having a different input image resolution can be interpolated to match the spatial features size of student model 148.

At step 510, multi-teacher model trainer 116 computes an image-level loss and a spatial loss corresponding to each student head 206. Image-level losses can be computed based on image-level feature differences between each corresponding teacher model 208 and student model 148. Differences of image-level features can be computed using any technically feasible metric, such as Cosine similarity, L1, Mean Square Error (MSE), and/or smooth-L1. Spatial losses are based on spatial feature differences between outputs generated by each corresponding teacher model and student model 148. The differences between spatial features can be computed using any technically feasible metric, such as Cosine similarity, L1, Mean Square Error (MSE), or smooth-L1. In some embodiments, multi-teacher model trainer 116 can adjust spatial loss parameters to modify the weight of each term of the spatial loss.

At step 512, multi-teacher model trainer 116 computes a total loss for all student heads 206. In some embodiments, multi-teacher model trainer 116 aggregates the losses computed at step 510 and sets loss function weighting parameters. The loss function weighting parameters control the number of possible combinations of loss function terms between different teachers, choosing the teacher models included during the training and/or formulation of loss functions. Multi-teacher model trainer 116 can use image-level losses and spatial losses from distillation losses 210 corresponding to teacher models 208 to generate an aggregated loss. In some embodiments, the aggregated loss can be computed using weighting parameters that equally consider different loss terms. In some embodiments, multi-teacher model trainer 116 can set fixed values for each weighting parameter before the training begins. In some other embodiments, multi-teacher model trainer 116 can automatically change the weighting parameters in any technically feasible manner, including using a scheduling algorithm such as AdaLoss and Adaptive Multi-Teacher Multi-level Knowledge Distillation (AMTML-KD).

At step 514, multi-teacher model trainer 116 determines if the computed total loss is smaller than a predefined threshold. Method 500 continues to step 516 if multi-teacher model trainer 116 determines that the computed total loss is not smaller than the predefined threshold. On the other hand, method 500 ends and training is complete if multi-teacher model trainer 116 determines that the computed total loss is smaller than the predefined threshold.

At step 516, multi-teacher model trainer 116 updates student model 148 parameters and each student head 206 parameters based on the computed total loss. The computed total loss can be used to compute gradients for backpropagation to update parameters of student model 148 and student heads 206.

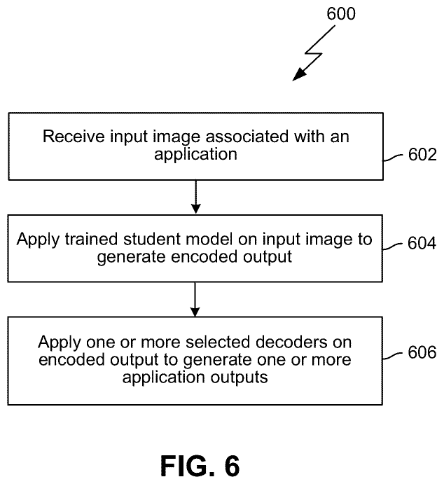

FIG. 6 is a flow diagram of method steps for using trained student model 404 to perform one or more tasks, according to various embodiments. Although the method steps are described in conjunction with the systems of FIGS. 1-4, persons skilled in the art will understand that any system configured to perform the method steps in any order falls within the scope of the present embodiments.

As shown, a method 600 begins at step 602, where application 146 receives input image 402 associated with a task. Application 146 receives input image 402 from memory 114, storage 120, or any other storage. In some embodiments, application 146 can receive multiple images 402 associated with different tasks.

At step 604, application 146 applies trained student model 404 on input image 402 to generate encoded output 406. Trained student model 404 is the output of multi-teacher model trainer 116 after training is completed with training images 202. In some embodiments, trained student model 404 receives multiple images 402 associated with different tasks. In such cases, trained student model 404 can generate multiple encoded outputs 406. Trained student model 404 can generate encoded output 406 for each task among different tasks.

At step 606, application 146 applies one or more selected decoders 408 on generated encoded output 406 to generate one or more application outputs 410. Each decoder 408 can be any technically feasible machine learning model that can be trained to generate decoder output 410. In some embodiments, decoders 408 can generate one or more outputs associated with one or more tasks, such as image classification, semantic segmentation, and caption generation. Examples of decoder outputs 410 include a caption for an image, a segmented image, and/or a heatmap image. In some embodiments, decoders 408 can include decoders of a VFM with any suitable architecture.

In sum, techniques are disclosed for training machine learning models using multi-teacher distillation. During the training, multiple teacher models, which can be FMs such as VFMs, are used to distill knowledge into a single student model. The distillation matches the features of the teacher models before processing any task-specific layer. In particular, features output by the student model can be matched to features output by each individual teacher model independently via different projection heads for each teacher model. The distillation optimizes parameters of the student model and the student model projection heads using losses that include (a) image-level features, and (b) dense image features for each image patch. An image-level loss can be based on a similarity metric computed from image-level features of the student model and each teacher model. A dense image loss can be based on a similarity metric computed from image patch features of the student model and each teacher model. To calculate losses for teacher models with different input image resolutions and different down sampling steps, image patches and features generated by the teacher models can be matched with input patches and features generated by the student model after cropping and interpolating the input patches and features generated by the student model.

At least one technical advantage of the disclosed techniques relative to the prior art is that the disclosed techniques can be used to generate relatively accurate and stable student foundation models that perform well across different tasks. The disclosed techniques also allow the student models to have an architecture that is distinct from the architecture of any teacher model. In addition, the trained student models can be faster and more data efficient, since the disclosed techniques do not rely on any prior feature shapes or model architecture. These technical advantages represent one or more technological improvements over prior art approaches.
1. In some embodiments, a computer-implemented method for training a first machine learning model comprises processing first data via a plurality of trained machine learning models to generate a plurality of first outputs, processing the first data via the first machine learning model to generate a second output, processing the second output via a plurality of projection heads to generate a plurality of third outputs, computing a plurality of losses based on the plurality of first outputs and the plurality of third outputs, and performing one or more operations to update one or more parameters of the first machine learning model and one or more parameters of the plurality of projection heads based on the plurality of losses.
2. The computer-implemented method of clause 1, wherein the first machine learning model comprises a hybrid convolutional and transformer neural network.
3. The computer-implemented method of clauses 1 or 2, wherein each projection head included in the plurality of projection heads comprises a multi-layer perceptron.
4. The computer-implemented method of any of clauses 1-3, wherein each of the first machine learning model and the plurality of trained machine learning models comprises an encoder model.
5. The computer-implemented method of any of clauses 1-4, wherein each of the first machine learning model and the plurality of trained machine learning models comprises a foundation model.
6. The computer-implemented method of any of clauses 1-5, wherein computing the plurality of losses comprises, for each first output included in the plurality of first outputs, computing a cosine distance between one or more first summary features included in the first output and one or more second summary features included in one of the plurality of third outputs that corresponds to the first output.
7. The computer-implemented method of any of clauses 1-6, wherein computing the plurality of losses comprises, for each first output included in the plurality of first outputs, computing a combination of a cosine distance and a smooth L1 distance between one or more first spatial features included in the first output and one or more second spatial features included in one of the plurality of third outputs that corresponds to the first output.
8. The computer-implemented method of any of clauses 1-7, wherein performing the one or more operations to update the one or more parameters of the first machine learning model and the one or more parameters of the plurality of projection heads comprises computing a plurality of gradients based on the plurality of losses, and performing one or more backpropagation operations to update the one or more parameters of the first machine learning model and the one or more parameters of the plurality of projection heads based on the plurality of gradients.
9. The computer-implemented method of any of clauses 1-8, wherein the plurality of losses are weighted equally when performing the one or more operations to update the one or more parameters of the first machine learning model and the one or more parameters of the plurality of projection heads.
10. The computer-implemented method of any of clauses 1-9, wherein performing one or more operations to update the one or more parameters of the first machine learning model and the one or more parameters of the plurality of projection heads comprises performing one or more automatic loss balancing operations to determine a weight for each loss included in the plurality of losses.
11. In some embodiments, one or more non-transitory computer-readable storage media include instructions that, when executed by at least one processor, cause the at least one processor to perform steps for training a first machine learning model, the steps comprising processing first data via a plurality of trained machine learning models to generate a plurality of first outputs, processing the first data via the first machine learning model to generate a second output, processing the second output via a plurality of projection heads to generate a plurality of third outputs, computing a plurality of losses based on the plurality of first outputs and the plurality of third outputs, and performing one or more operations to update one or more parameters of the first machine learning model and one or more parameters of the plurality of projection heads based on the plurality of losses.
12. The one or more non-transitory computer-readable storage media of clause 11, wherein the first machine learning model comprises a hybrid convolutional and transformer neural network.
13. The one or more non-transitory computer-readable storage media of clauses 11 or 12, wherein computing the plurality of losses comprises, for each first output included in the plurality of first outputs, computing a cosine distance between one or more first summary features included in the first output and one or more second summary features included in one of the plurality of third outputs that corresponds to the first output.
14. The one or more non-transitory computer-readable storage media of any of clauses 11-13, wherein computing the plurality of losses comprises, for each first output included in the plurality of first outputs, computing a combination of a cosine distance and a smooth L1 distance between one or more first spatial features included in the first output and one or more second spatial features included in one of the plurality of third outputs that corresponds to the first output.
15. The one or more non-transitory computer-readable storage media of any of clauses 11-14, wherein performing the one or more operations to update the one or more parameters of the first machine learning model and the one or more parameters of the plurality of projection heads comprises computing a plurality of gradients based on the plurality of losses, and performing one or more backpropagation operations to update the one or more parameters of the first machine learning model and the one or more parameters of the plurality of projection heads based on the plurality of gradients.
16. The one or more non-transitory computer-readable storage media of any of clauses 11-15, wherein the plurality of losses are weighted equally when performing the one or more operations to update the one or more parameters of the first machine learning model and the one or more parameters of the plurality of projection heads.
17. The one or more non-transitory computer-readable storage media of any of clauses 11-16, wherein the processing the first data via the plurality of trained machine learning models comprises processing the first data via each trained machine learning model included in the plurality of trained machine learning models using a different set of processors.
18. The one or more non-transitory computer-readable storage media of any of clauses 11-17, wherein the instructions, when executed by the at least one processor, further cause the at least one processor to perform the steps of, subsequent to the updating the one or more parameters of the first machine learning model, processing second data via the first machine learning model to generate a fourth output, and processing the fourth output via a decoder model to generate a fifth output.
19. The one or more non-transitory computer-readable storage media of any of clauses 11-18, wherein processing the first data via the plurality of trained machine learning models comprises performing one or more interpolation operations on the first data to generate interpolated data, and inputting the interpolated data into at least one trained machine learning model included in the plurality of trained machine learning models.
20. In some embodiments, a system comprises one or more memories storing instructions, and one or more processors that are coupled to the one or more memories and, when executing the instructions, are configured to process first data via a plurality of trained machine learning models to generate a plurality of first outputs, process the first data via a first machine learning model to generate a second output, process the second output via a plurality of projection heads to generate a plurality of third outputs, compute a plurality of losses based on the plurality of first outputs and the plurality of third outputs, and perform one or more operations to update one or more parameters of the first machine learning model and one or more parameters of the plurality of projection heads based on the plurality of losses.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for training a first machine learning model, the method comprising:
processing first data via a plurality of trained machine learning models to generate a plurality of first outputs;
processing the first data via the first machine learning model to generate a second output;
processing the second output via a plurality of projection heads to generate a plurality of third outputs;
computing a plurality of losses based on the plurality of first outputs and the plurality of third outputs; and
performing one or more operations to update one or more parameters of the first machine learning model and one or more parameters of the plurality of projection heads based on the plurality of losses.

2. The computer-implemented method of claim 1, wherein the first machine learning model comprises a hybrid convolutional and transformer neural network.

3. The computer-implemented method of claim 1, wherein each projection head included in the plurality of projection heads comprises a multi-layer perceptron.

4. The computer-implemented method of claim 1, wherein each of the first machine learning model and the plurality of trained machine learning models comprises an encoder model.

5. The computer-implemented method of claim 1, wherein each of the first machine learning model and the plurality of trained machine learning models comprises a foundation model.

6. The computer-implemented method of claim 1, wherein computing the plurality of losses comprises, for each first output included in the plurality of first outputs, computing a cosine distance between one or more first summary features included in the first output and one or more second summary features included in one of the plurality of third outputs that corresponds to the first output.

7. The computer-implemented method of claim 1, wherein computing the plurality of losses comprises, for each first output included in the plurality of first outputs, computing a combination of a cosine distance and a smooth L1 distance between one or more first spatial features included in the first output and one or more second spatial features included in one of the plurality of third outputs that corresponds to the first output.

8. The computer-implemented method of claim 1, wherein performing the one or more operations to update the one or more parameters of the first machine learning model and the one or more parameters of the plurality of projection heads comprises:
computing a plurality of gradients based on the plurality of losses; and
performing one or more backpropagation operations to update the one or more parameters of the first machine learning model and the one or more parameters of the plurality of projection heads based on the plurality of gradients.

9. The computer-implemented method of claim 1, wherein the plurality of losses are weighted equally when performing the one or more operations to update the one or more parameters of the first machine learning model and the one or more parameters of the plurality of projection heads.

10. The computer-implemented method of claim 1, wherein performing one or more operations to update the one or more parameters of the first machine learning model and the one or more parameters of the plurality of projection heads comprises performing one or more automatic loss balancing operations to determine a weight for each loss included in the plurality of losses.

11. One or more non-transitory computer-readable storage media including instructions that, when executed by at least one processor, cause the at least one processor to perform steps for training a first machine learning model, the steps comprising:
processing first data via a plurality of trained machine learning models to generate a plurality of first outputs;
processing the first data via the first machine learning model to generate a second output;
processing the second output via a plurality of projection heads to generate a plurality of third outputs;
computing a plurality of losses based on the plurality of first outputs and the plurality of third outputs; and
performing one or more operations to update one or more parameters of the first machine learning model and one or more parameters of the plurality of projection heads based on the plurality of losses.

12. The one or more non-transitory computer-readable storage media of claim 11, wherein the first machine learning model comprises a hybrid convolutional and transformer neural network.

13. The one or more non-transitory computer-readable storage media of claim 11, wherein computing the plurality of losses comprises, for each first output included in the plurality of first outputs, computing a cosine distance between one or more first summary features included in the first output and one or more second summary features included in one of the plurality of third outputs that corresponds to the first output.

14. The one or more non-transitory computer-readable storage media of claim 11, wherein computing the plurality of losses comprises, for each first output included in the plurality of first outputs, computing a combination of a cosine distance and a smooth L1 distance between one or more first spatial features included in the first output and one or more second spatial features included in one of the plurality of third outputs that corresponds to the first output.

15. The one or more non-transitory computer-readable storage media of claim 11, wherein performing the one or more operations to update the one or more parameters of the first machine learning model and the one or more parameters of the plurality of projection heads comprises:
computing a plurality of gradients based on the plurality of losses; and
performing one or more backpropagation operations to update the one or more parameters of the first machine learning model and the one or more parameters of the plurality of projection heads based on the plurality of gradients.

16. The one or more non-transitory computer-readable storage media of claim 11, wherein the plurality of losses are weighted equally when performing the one or more operations to update the one or more parameters of the first machine learning model and the one or more parameters of the plurality of projection heads.

17. The one or more non-transitory computer-readable storage media of claim 11, wherein the processing the first data via the plurality of trained machine learning models comprises processing the first data via each trained machine learning model included in the plurality of trained machine learning models using a different set of processors.

18. The one or more non-transitory computer-readable storage media of claim 11, wherein the instructions, when executed by the at least one processor, further cause the at least one processor to perform the steps of, subsequent to the updating the one or more parameters of the first machine learning model;
processing second data via the first machine learning model to generate a fourth output; and
processing the fourth output via a decoder model to generate a fifth output.

19. The one or more non-transitory computer-readable storage media of claim 11, wherein processing the first data via the plurality of trained machine learning models comprises:
performing one or more interpolation operations on the first data to generate interpolated data; and
inputting the interpolated data into at least one trained machine learning model included in the plurality of trained machine learning models.

20. A system, comprising:
one or more memories storing instructions; and
one or more processors that are coupled to the one or more memories and, when executing the instructions, are configured to:
process first data via a plurality of trained machine learning models to generate a plurality of first outputs,
process the first data via a first machine learning model to generate a second output,
process the second output via a plurality of projection heads to generate a plurality of third outputs,
compute a plurality of losses based on the plurality of first outputs and the plurality of third outputs, and
perform one or more operations to update one or more parameters of the first machine learning model and one or more parameters of the plurality of projection heads based on the plurality of losses.
